(19) United States
(12) Patent Application Publication
(10) Pub. No.: US 2012/0268720 A1
(43) Pub. Date: Oct. 25, 2012

(54) OPTICAL DEVICE, METHOD FOR MANUFACTURING THE SAME, AND PROJECTOR APPARATUS INCLUDING THE SAME

(75) Inventors: CHIEH-WEN WANG, TAIPEI (TW); WEI-JIE PENG, TAIPEI (TW); WEI-HWA LEE, TAIPEI (TW)

(73) Assignees: LITE-ON TECHNOLOGY CORP., TAIPEI (TW); SILITEK ELECTRONIC (GUANGZHOU) CO., LTD., GUANGZHOU (CN)

(21) Appl. No.: 13/293,285

(22) Filed: Nov. 10, 2011

(30) Foreign Application Priority Data
Apr. 25, 2011 (CN) 201110109125.4

(51) Int. Cl. G03B 21/28; C23F 1/02; B32B 37/06; G02B 5/04; B32B 37/12

(52) U.S. Cl. 353/81; 359/831; 359/837; 156/60; 156/275.5; 216/24

(57) ABSTRACT

An optical device includes a first prism unit, a second prism unit spaced apart from the first prism unit, and a spacer unit disposed between the first and second prism units. Each of the first and second prism units includes a substrate, an anti-reflection coating, and a prism. The substrate has a first surface disposed to face the other one of the first and second prism units, and a second surface opposite to the first surface. The anti-reflection coating is disposed on the first surface of the substrate. The prism is disposed adjacent to the second surface of the substrate. The spacer unit is disposed between the anti-reflection coatings of the first and second prism units.

### CROSS-REFERENCE TO RELATED APPLICATION

This application claims priority of Chinese Application No. 201110109125.4, filed on Apr. 25, 2011.

### BACKGROUND OF THE INVENTION

1. Field of the Invention

The present invention relates to an optical device, more particularly to an optical device used for reflecting light beams and adjusting optical path, a method for manufacturing the optical device, and a projector apparatus including the optical device.

2. Description of the Related Art

For a current projector apparatus, an illuminating light source should be separated from a projecting light source in the projector apparatus so as to obtain a sharper projected image. A prism unit has been widely applied in the projector apparatus for separating optical paths of the illuminating light source and the projecting light source. Referring to FIG. 1, a conventional prism unit 1 of a projector apparatus 2 is illustrated. The prism unit 1 includes two prisms 11 each having a surface 111 facing the other prism 11, two anti-reflection coatings 12 each applied to the surface 111 of a respective one of the prisms 11, and a plurality of spacers 13 disposed between the anti-reflection coatings 12. Each of the anti-reflection coatings 12 includes a plurality of thin films arranged in a stack (only one thin film is illustrated in FIG. 1). The spacers 13 serve to space apart the prisms 11 from each other such that there is an air gap 14 located between the two prisms 11.

During use, light beams of the projector apparatus 2 are first reflected by a reflecting unit 21 of the projector apparatus 2 toward one of the prisms 11 proximate to the reflecting unit 21. The light beams are then totally reflected by a boundary between the anti-reflection coating 12 and the air gap 14 toward a digital micromirror device (DMD) 22 of the projector apparatus 2. A portion of the reflected light beams enters the DMD 22 to serve as an illuminating light source. Another portion of the reflected light beams is reflected by the DMD 22, passes through the two prisms 11, and is directed into a projector lens (not shown) to serve as a projecting light source.

Referring to FIG. 2, another type of a projector apparatus 2′ is illustrated. The prism unit 1 is similarly adopted in the projector apparatus 2′, but optical path of the prism unit 1 is substantially opposite to that of the projector apparatus 2 shown in FIG. 1. In detail, the light beams pass through the two prisms 11 toward the DMD 22′. A portion of the light beams enters the DMD 22′ to serve as the illuminating light source, and another portion of the light beams is reflected by the DMD 22′ toward one of the prisms 11 proximate to the DMD 22′, and is totally reflected by said one of the prisms 11 proximate to the DMD 22′ toward the projector lens (not shown) to serve as the projecting light source.

Regardless of the projector apparatus 2 in FIG. 1 or the projector apparatus 2′ in FIG. 2, the prism unit 1 with the same structure is adopted. When manufacturing the prism unit 1, it is required that the two polished prisms 11 are spaced apart from each other by ball-shaped spacers 13, and are adhesively bonded together after alignment adjustment. In general, since the prisms 11, unlike cuboids or plate-shaped articles, are substantially irregular in shape, it is difficult to clamp and align the prisms 11 when bonding the prisms 11 together, such that manufacture of the prism unit 1 is not easy. Moreover, prior to bonding the prisms 11 together, a specific clamping jig is required for fixing the prisms 11, and a coating process is performed on the surface 111 of each of the prisms 11 so as to form the anti-reflection coatings 12. Considering that the prisms 11 are substantially irregular in shape and the specific clamping jig is required for fixing the prisms 11, process efficiency is limited when performing the coating process on the prisms 11. Therefore, the coating process may not be performed on a large number of the prisms 11 at a time, such that a higher coating cost is incurred, and quality variance of the prisms 11 may not be precisely controlled.

### SUMMARY OF THE INVENTION

Therefore, an object of the present invention is to provide an optical device which is easy to manufacture, which has a lower coating cost resulting from a large area coating process, and which has relatively small quality variance, and to provide a method for manufacturing the optical device, and a projector apparatus including the optical device.

In a first aspect of the present invention, the optical device comprises a first prism unit, a second prism unit corresponding to and spaced apart from the first prism unit, and a spacer unit disposed between the first and second prism units. Each of the first and second prism units includes a substrate, an anti-reflection coating, and a prism. The substrate has a first surface disposed to face the other one of the first and second prism units, and a second surface opposite to the first surface. The anti-reflection coating is disposed on the first surface of the substrate. The prism is disposed adjacent to the second surface of the substrate. The spacer unit is disposed between the anti-reflection coatings of the first and second prism units.

It is noted here that the prism is disposed “adjacent to” the second surface of the substrate. This means that the prism may be directly fixed on the second surface of the substrate, or the prism may be indirectly mounted to the substrate via a refractive index matching layer.

In a second aspect, the method for manufacturing the optical device, according to the present invention, comprises the steps of:

(A) providing a first substrate unit and a second substrate unit, each having a substrate with opposite first and second surfaces, and an anti-reflection coating formed on the first surface of the substrate;

(B) disposing a spacer unit on at least one of the anti-reflection coatings of the first and second substrate units;

(C) stacking together the first and second substrate units with the spacer unit disposed between the anti-reflection coatings of the first and second substrate units;

(D) bonding the first and second substrate units and the spacer unit together; and

(E) for each of the first and second substrate units, disposing a prism adjacent to the second surface of the substrate.

In a third aspect of the present invention, aside from the optical device, the projector apparatus further comprises a light source, a digital micromirror device disposed at one side of the first prism unit of the optical device, and a projector lens. The first prism unit of said optical device is disposed to reflect light beams emitted from the light source toward the digital micromirror device, and the digital micromirror device is disposed to reflect the light beams received from the first prism unit such that the light beams reflected by the digital micromirror device pass through the first and second prism units and enter the projector lens.

Preferably, the projector apparatus further comprises a reflecting unit disposed at one side of the optical device. The light beams emitted from the light source are directed toward the reflecting unit and are reflected by the reflecting unit to enter the first prism unit of the optical device.

Therefore, the light beams received by the prism unit may be: the light beams which are emitted from the light source and directly toward the prism unit (at this time, the reflecting unit may be omitted), or the light beams which are emitted from the light source, directed toward the reflecting unit, and reflected by the reflecting unit to enter the first prism unit (such as a first preferred embodiment of the present invention illustrated in FIG. 3).

Furthermore, an optical path of the projector apparatus of the present invention may be alternatively designed as following: The light beams emitted from the light source pass through the first and second prism units toward the digital micromirror device. The digital micromirror device is disposed to reflect the light beams passing through the first and second prism units toward the first prism unit, and the first prism unit is disposed to reflect the light beams received from the digital micromirror device toward the projector lens.

The effect of the present invention resides in that a total internal reflection function is implemented through the substrate. A large area coating process may be performed on the substrates that are laid flat so as to apply the anti-reflection coatings thereon. In this way, variance of coating layers of the optical devices is reduced such that quality of the optical device may be ensured. Moreover, by disposing each of the prisms adjacent to the planar second surface of the corresponding substrate, the prisms may be aligned and fastened with relative ease, so as to achieve effects of easy manufacturing and cost reduction.

### BRIEF DESCRIPTION OF THE DRAWINGS

Other features and advantages of the present invention will become apparent in the following detailed description of the three preferred embodiments with reference to the accompanying drawings, of which:

FIG. 1 is a schematic diagram illustrating partial components of a conventional projector apparatus;

FIG. 2 is a schematic diagram illustrating partial components of another conventional projector apparatus;

FIG. 3 is a schematic diagram illustrating a first preferred embodiment of an optical device of the present invention, and relative dispositions of the optical device with respect to other components in a projector apparatus;

FIG. 4 is a schematic diagram similar to FIG. 3, illustrating that a field lens may be included in the optical device of the present invention;

FIG. 5 is a schematic diagram similar to FIG. 3, illustrating another application of the optical device of the present invention;

FIG. 6 is a flow chart illustrating a method for manufacturing the first preferred embodiment of the optical device according to the present invention;

FIG. 7 is a schematic diagram showing the method for manufacturing the first preferred embodiment;

FIG. 8 is a top view showing that a large area anti-reflection coating is divided to form a plurality of square areas, and each square area represents a cross-sectional dimension at which the optical device of the present invention is to be manufactured;

FIG. 9 is a side view showing that by means of a large area coating process, a plurality of the optical devices of the present invention may be produced at the same time, and the broken lines represent cutting positions for dividing the large area anti-reflection coating;

FIG. 10 is a schematic diagram illustrating a second preferred embodiment of the optical device of the present invention;

FIG. 11 is a schematic diagram showing partial steps of a method for manufacturing the second preferred embodiment of the optical device according to the present invention; and

FIG. 12 is a schematic diagram illustrating a third preferred embodiment of the optical device of the present invention.

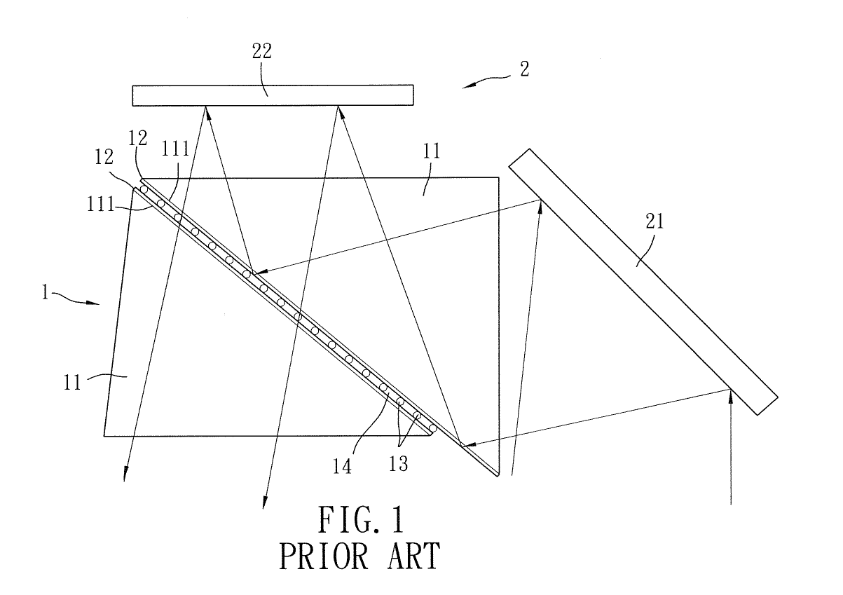

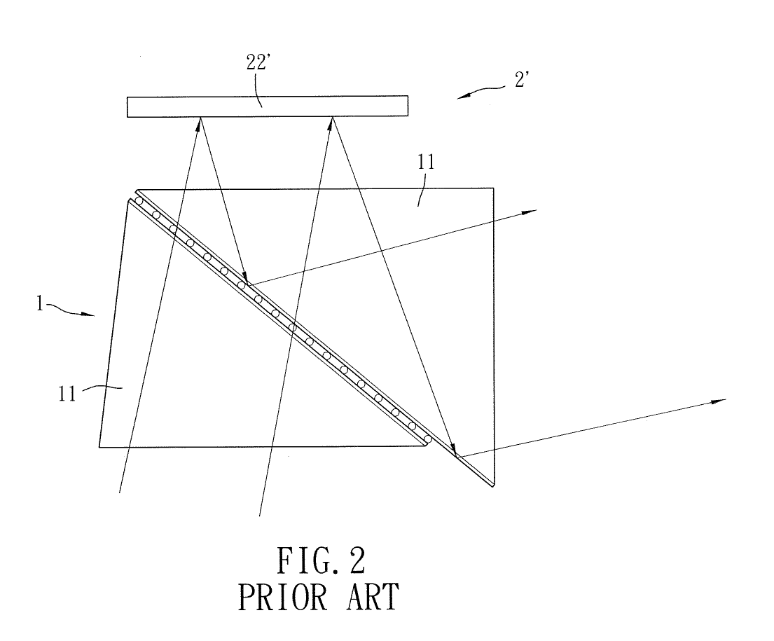

### DETAILED DESCRIPTION OF THE PREFERRED EMBODIMENTS

Before the present invention is described in greater detail, it should be noted that like elements are denoted by the same reference numerals throughout the disclosure.

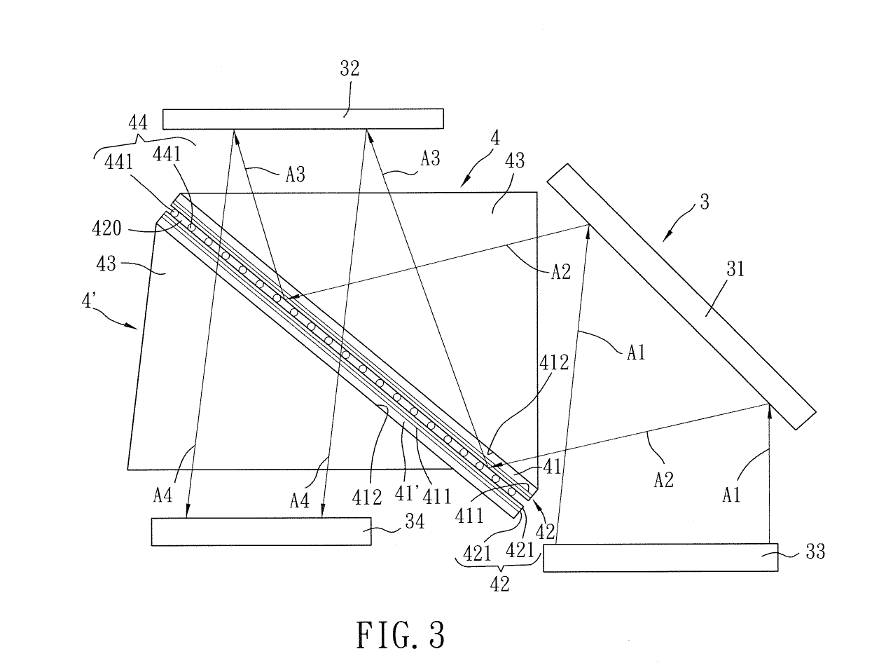

Referring to FIG. 3, a first preferred embodiment of the optical device, according to the present invention, is applicable to a projector apparatus 3. The projector apparatus 3 includes, aside from the optical device, a light source 33, a reflecting unit 31, a digital micromirror device (DMD) 32, and a projector lens 34. Naturally the projector apparatus further comprises optical filters and other components. Since the feature of the present invention does not reside in the detailed configuration of the optical filters and other components, further details of the same are omitted herein for the sake of brevity.

The optical device, according to the present invention, comprises a first prism unit 4, a second prism unit 4′ corresponding to and spaced apart from the first prism unit 4, and a spacer unit 44 disposed between the first and second prism units 4, 4′. Each of the first and second prism units 4, 4′ includes a substrate 41 (41′), an anti-reflection coating 42, and a prism 43. It should be noted that when the first and second prism units 4, 4′ are disposed at relative positions in the projector apparatus 3 as illustrated in FIG. 3, the first prism unit 4 is disposed proximate to the reflecting unit 31 and the DMD 32, and the second prism unit 4′ is disposed away from the reflecting unit 31 and the DMD 32. Since the substrate 41 of the first prism unit 4 functions substantially different from the substrate 41′ of the second prism unit 4′, they are given different reference numerals for distinction.

The substrates 41, 41′ are both transparent and plate-shaped glass substrates, and have different functions. For the substrate 41 of the first prism unit 4, total internal reflection may occur thereat, i.e., total reflection happens when light beams strike the substrate 41 of the first prism unit 4 at an angle (angle of incidence) larger than a critical angle, and the light beams pass through the substrate 41 of the first prism unit 4 when the angle of incidence is smaller than the critical angle (such as light beams reflected by the DMD 32 and directed toward the substrate 41). Thus, the substrate 41 of the first prism unit 4 may be a total internal reflection plate. On the other hand, the substrate 41′ of the second substrate 4′ is mainly adapted for passage of light beams, and functions substantially different from the substrate 41 of the first prism unit 4 serving as the total internal reflection plate. However, in practice, the functions of the substrates 41, 41′ are not limited to the above disclosure. When a disposition direction of the present invention varies, the substrate 41′ of the second prism unit 4′ may function as a total internal reflection plate, and the substrate 41 of the first prism unit 4 may be adapted for passage of the light beams.

Each of the substrate 41 of the first prism unit 4 and the substrate 41′ of the second prism unit 4′ has a first surface 411 disposed to face the other one of the first and second prism units 4, 4′, and a second surface 412 opposite to the first surface 411. The substrates 41, 41′ are disposed with the first surfaces 411 facing each other, and are spaced apart from each other by a proper distance. Thickness of each of the substrates 41, 41′ may be selected from 0.5 mm, 0.7 mm, 1.0 mm, and over 1.0 mm, but is not limited to the disclosure in the present invention.

For each of the first and second prism units 4, 4′, the anti-reflection coating 42 is disposed on the first surface 411 of the substrate 41 (41′). The anti-reflection coating 42 includes a plurality of thin film layers 421 arranged in a stack (only two layers are illustrated in FIG. 3), and may be formed by periodically stacking two or more than two kinds of thin films made of different materials. By means of variations in refractive indices of adjacent thin film layers 421, an effect of anti-reflection is achieved. Since the multi-layer structure of the anti-reflection coating 42 is known in the art, details of the same are omitted herein for the sake of brevity.

For each of the first and second prism units 4, 4′, the prism 43 is mounted to the second surface 412 of the substrate 41 (41′). A refractive index of the prism 43 may be equal to or different from that of the substrate 41 (41′) for changing the critical angle associated with occurrence of total reflection. A function of the prism 43 of the present invention is different from that of a prism of a conventional prism unit. The conventional prism is a total internal reflection prism. However, in the present invention, the substrate 41 of the first prism unit 4 in FIG. 3 is adopted for providing a total internal reflection function, and the prism 43 is used for compensating an optical path of the optical device so as to achieve effects of astigmatism correction and aberration reduction.

The spacer unit 44 is disposed between the anti-reflect ion coatings 42 of the first and second prism units 4, 4′. The spacer unit 44 includes a plurality of spacers 441 that are spaced apart from each other and that are made of glass. However, the spacers 441 are not limited to the type and material mentioned herein, for example, the spacers 441 may be made of optical fiber material, photoresist material, etc. The spacer unit 44 is used to space the first and second prism units 4, 4′ apart from each other so as to form an air gap 420 located between the anti-reflection coatings 42. A boundary is formed between the air gap 420 and each of the anti-reflection coatings 42 for occurrence of the total internal reflection. A thickness of the air gap 420 is substantially equal to a distance by which the two anti-reflection coatings 42 are spaced apart from, is substantially equal to a diameter of the spacer unit 44, and ranges from about 5 micrometers to about 20 micrometers. Within this range, a better total internal reflection function may be provided.

During use of the present invention, light beams A1 emitted from the light source 33 are directed toward the reflecting unit 31 and are reflected by the reflecting unit 31 so as to form light beams A2. The light beams A2 from the reflecting unit 31 enter the first prism unit 4, and are totally reflected by the boundary between the air gap 420 and the anti-reflection coating 42 on the substrate 41 of the first prism unit 4 toward the digital micromirror device (DMD) 32 so as to form illuminating light beams A3. A portion of the illuminating light beams A3 directed toward the DMD 32 is reflected by the DMD 32, passes through the first and second prism units 4, 4′, and enters the projector lens 34 so as to form projecting light beams A4. When the light beams A4 are directed to the first and second prism units 4, 4′, by means of the anti-reflection coatings 42, most of the light beams A4 may pass through the first and second prism units 4, 4′, and multiple reflections happening at boundaries between different materials may be reduced. In this way, light beams reflected by the boundaries between different materials may be prevented from interfering with the light beams A4 passing through the first and second prism units 4, 4′, so as to reduce stray light and promote efficiency of the first and second prism units 4, 4′.

It should be noted that, even though in this embodiment, the light beams emitted from the light source 33 are directed into the optical device via the reflecting unit 31, in practice, disposition of the light source 33 may be adjusted such that the light beams emitted from the light source 33 are directly guided toward the optical device. At this time, the reflecting unit 31 may be omitted.

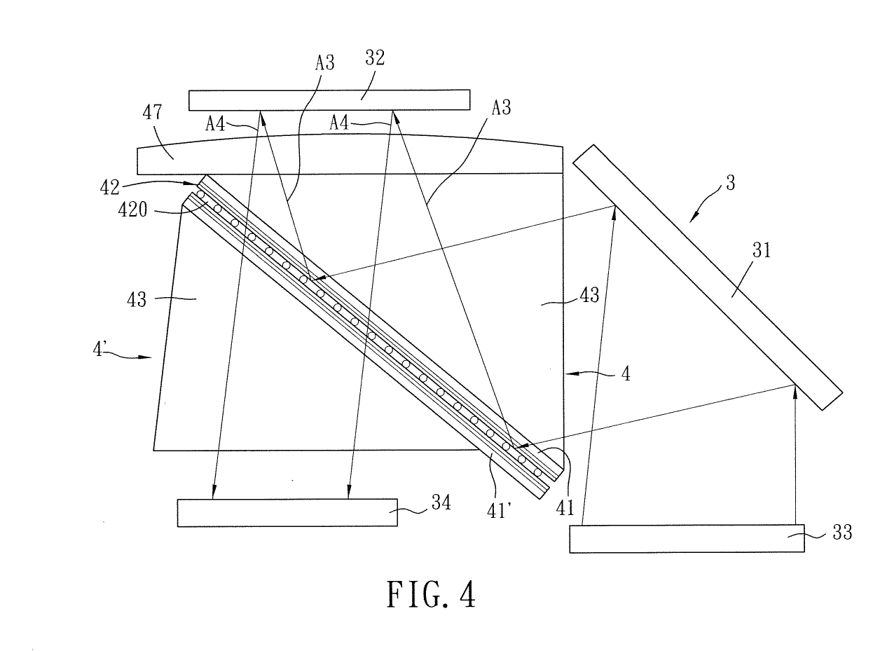

Referring to FIG. 4, in application, the optical device of the present invention may further comprise a field lens 47. The field lens 47 may be a convex lens, and may be disposed between the DMD 32 and the prism 43 of the first prism unit 4. The field lens 47 is adapted for converging the light beams A3 which are totally reflected by the boundary between the air gap 420 and the anti-reflection coating 42 on the substrate 41 of the first prism unit 4, and for converging the projecting light beams A4 which are reflected by the DMD 32 toward the optical device and the projector lens 34, such that a light angle of the light beams A4 is adjusted so as to converge projecting light and increase efficiency of the projector apparatus. The field lens 47 is not limited to the convex lens. When a concave lens is adopted as the field lens, different effects may be achieved.

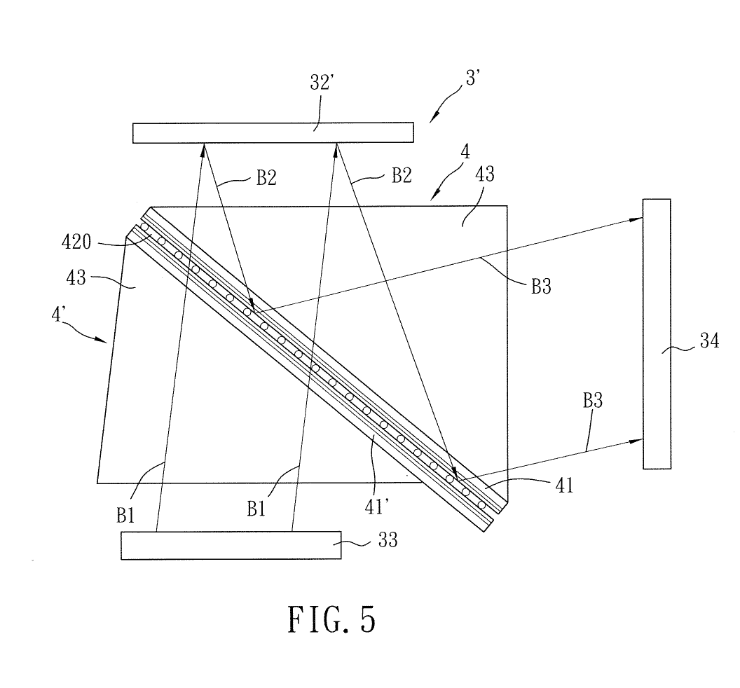

Referring to FIG. 5, the optical device of the present invention may be further applicable to another type of projector apparatus 3′. The projector apparatus 3′ does not include the reflecting unit 31 as illustrated in FIG. 3. Light beams B1 emitted from the light source 33 pass through the first and second prism units 4, 4′, and are directed toward the DMD 32′ so as to form illuminating light beams. A portion of the light beams B1 is reflected by the DMD 32′ toward the first prism unit 4 so as to form light beams B2. The light beams B2 from the DMD 32′ are totally reflected by the first prism unit 4 toward the projector lens 34 so as to form projecting light beams B3. In other words, compared with the projector apparatus 3 in FIG. 3 wherein the illuminating light beams A3 are totally reflected, the projector apparatus 3′ in FIG. 5 adopts a design in which the projecting light beams B3 are totally reflected.

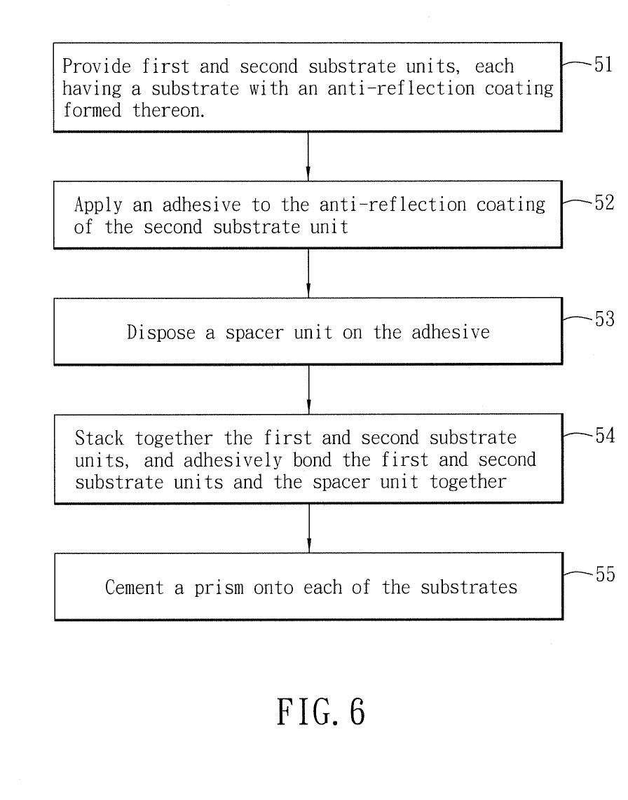

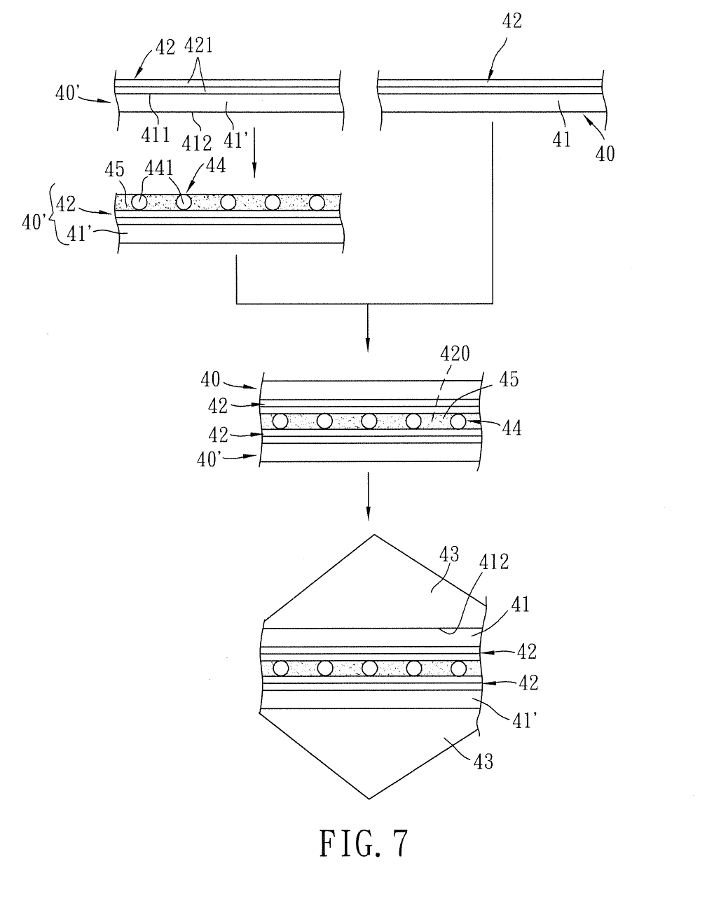

Referring to FIG. 3, FIG. 6 and FIG. 7, a method for manufacturing the first preferred embodiment of the optical device, according to the present invention, comprises the steps of:

Step 51: providing a first substrate unit 40 and a second substrate unit 40′, each having the substrate 41 (41′) with opposite first and second surfaces 411, 412, and the anti-reflection coating 42 formed on the first surface 411 of the substrate 41, 41′. The first and second substrate units 40, 40′ are produced in the same way. By means of evaporation deposition or sputter deposition, the thin film layers 421 are arranged in a stack on the first surface 411 of each of the substrates 41, 41′ so as to form the anti-reflection coatings 42.

Step 52: applying an adhesive 45 to the anti-reflection coating 42 of the second substrate unit 40′, and the adhesive 45 is applied to peripheral edges of the anti-reflection coating 42. In this embodiment, the adhesive 45 is a thermal curable adhesive, preferably an ultraviolet light curable adhesive, but is not limited to the disclosure herein. It is noted that the adhesive 45 is depicted in FIG. 7 but omitted in FIG. 3.

Step 53: disposing the spacer unit 44 on the adhesive 45 applied to the anti-reflection coating 42 of the second substrate unit 40′. In this embodiment, the spacer unit 44 is implemented using a plurality of balls made of glass and having diameters ranging from about 5 micrometers to about 20 micrometers. The glass balls are disposed at the peripheral edges of the anti-reflection coating 42 and are uniformly spaced apart from each other.

It should be noted that, steps 52 and 53 are adopted for disposing the spacer unit 44 on at least one of the anti-reflection coatings 42 of the first and second substrate units 40, 40′, but the method of this invention is not limited to the disclosure in this preferred embodiment.

Step 54: stacking together the first and second substrate units 40, 40′ with the spacer unit 44 disposed between the anti-reflection coatings 42 of the first and second substrate units 40, 40′. During this step, the first substrate unit 40 which is not applied with the adhesive 45 is disposed onto the spacer unit 44 with the anti-reflection coating 42 of the first substrate unit 40 facing the spacer unit 44, and the first and second substrate units 40, 40′ are pressed together, such that the adhesive 45 simultaneously contacts the anti-reflection coatings 42 of the first and second substrate units 40, 40′. Subsequently, the adhesive 45 is cured by irradiation with ultraviolet light so as to bond the first and second substrate units 40, 40′ and the spacer unit 44 together. At this time, the air gap 420 is formed between the anti-reflection coatings 42 as a result of the spacer unit 44.

Step 55: for each of the first and second substrate units 40, 40′, cementing the prism 43 onto the second surface 412 of the substrate 41 (41′), thereby completing manufacture of the optical device. It should be noted that, alternatively, the first and second substrate units 40, 40′ and the prisms 43 may be inserted into holders of the projector apparatus 3, such that for each of the first and second substrate units 40, 40′, the prism 43 is not required to be cemented onto the substrate 41 (41′) in advance, as long as the prism 43 is certainly disposed adjacent to the second surface 412 of the substrate 41 (41′).

It should be noted that, in the present invention, it is much easier to coat the substrates 41, 41′ that are laid flat compared to directly coating prisms which are three-dimensional in shape. Thus, the anti-reflection coatings 42 of the present invention may be formed through a large area coating process by means of evaporation deposition or sputter deposition, so as to reduce production time and cost. The large area coating process may be applied in the method for manufacturing the optical device of the present invention for accomplishing mass production of the optical devices at a time.

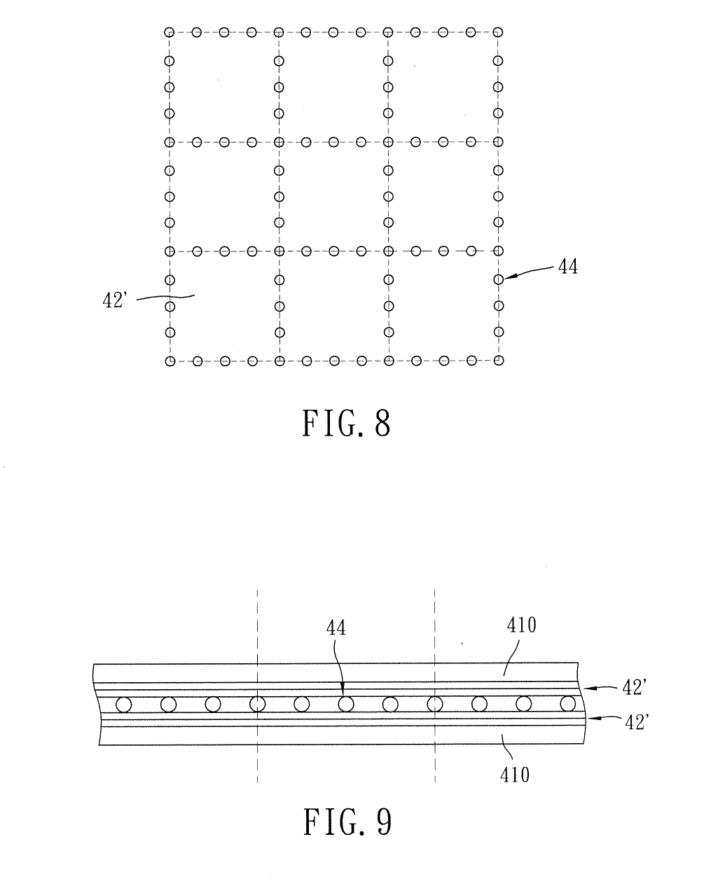

Reference is now made to FIG. 8 and FIG. 9. FIG. 8 is a top view in which broken lines are drawn to define nine square areas, and each square area represents a cross-sectional dimension at which the optical device of the present invention is to be manufactured. During manufacture, a large substrate 410 is coated with a large-area anti-reflection coating 42′, the adhesive 45 is applied to the large-area anti-reflection coating 42′ at predetermined positions (i.e., the positions of the broken lines), the spacer unit 44 is disposed on the adhesive 45, another large substrate 410 with the large-area anti-reflection coating 42′ is adhesively bonded to the large substrate 410 disposed with the spacer unit 44, and a plurality of semi-finished optical devices are finally derived via cutting along the positions of the broken lines illustrated in FIG. 8 and FIG. 9. Subsequently, a plurality of the optical device of the present invention may be manufactured at a time by cementing the prisms 43 onto the substrates 41, 41′ of each of the semi-finished optical devices.

To sum up, the substrates 41, 41′ are used to replace the conventional prisms for providing the total internal reflection function. A specific jig may be omitted when disposing the anti-reflection coatings 42 onto the substrates 41, 41′ that are laid flat, and the large area coating process may be adopted for reducing thin film variance among optical devices so as to maintain stable quality thereof. Moreover, since each of the prisms 43 is disposed adjacent to the planar second surface 412 of a respective one of the substrates 41, 41′, compared with a conventional manufacturing method which directly bonds two prisms together, the prisms 43 may be aligned and fastened with relative ease such that the present invention has advantages of easy manufacturing and cost reduction.

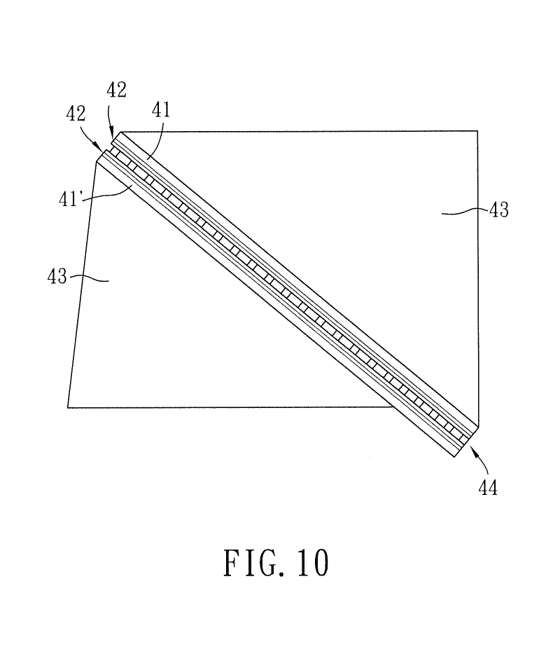

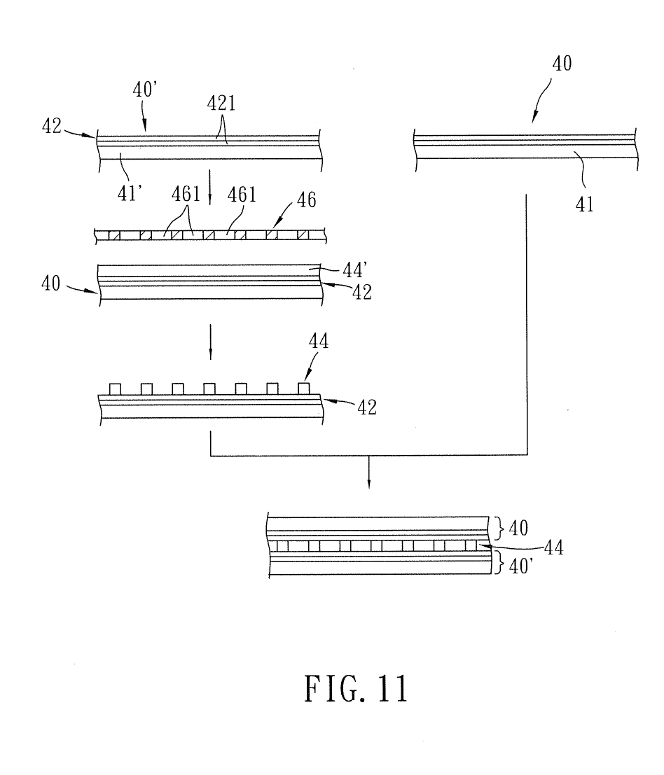

Referring to FIG. 10 and FIG. 11, a second preferred embodiment of the optical device, according to the present invention, is illustrated. The second preferred embodiment differs from the first preferred embodiment in the configuration that the spacer unit 44 of this embodiment is made of photoresist material and is in a shape of a thin film. In this case, the spacer unit 44 is in a form of a photo spacer. The method for manufacturing this embodiment is substantially the same as that for manufacturing the first preferred embodiment, such that only differences between the two methods are described hereinafter. The spacer unit 44 of this embodiment is made through photolithography etching techniques. After the first and second substrate units 40, 40′, each including the substrate 41 (41′) and the anti-reflection coating 42, are formed, the anti-reflection coating 42 of the second substrate unit 40′ is applied with a spacer layer 44′ made of photoresist material. A photomask 46 with a plurality of holes 461 is disposed above the spacer layer 44′, and the spacer layer 44′ is exposed to light via the photomask 46. An etching agent is used to remove parts of the spacer layer 44′ which are exposed to the light, and the other parts of the spacer layer 44′ which are not exposed to the light remain on the anti-reflection coating 42 so as to form the spacer unit 44. Subsequently, the adhesive 45 is applied to the spacer unit 44, and the first substrate unit 40 is adhesively bonded to the spacer unit 44. Afterward, the prisms 43 are disposed adjacent to the first and second substrate units 40, 40′.

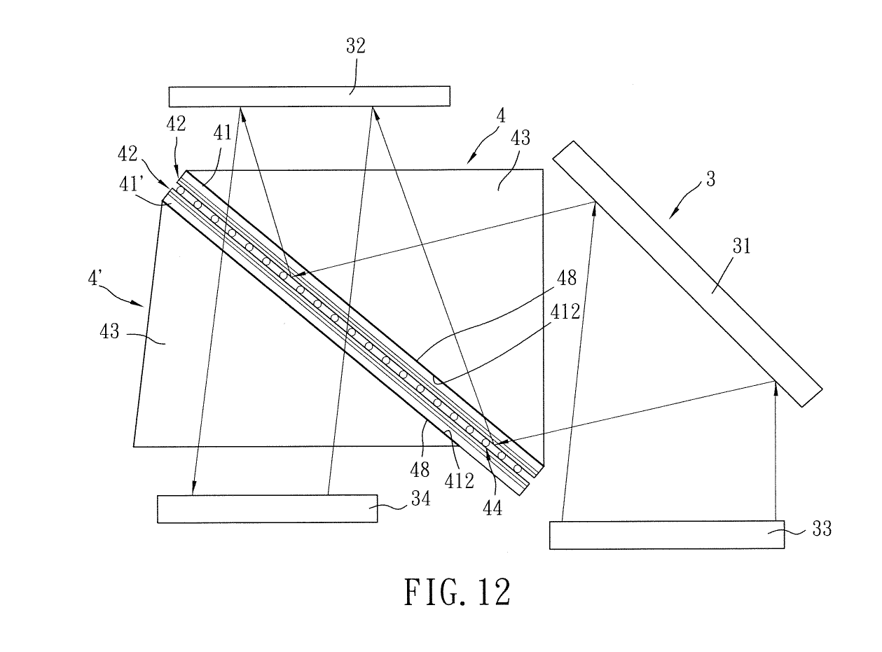

Referring to FIG. 12, a third preferred embodiment of the optical device, according to the present invention, is illustrated. The third preferred embodiment is substantially the same as the first preferred embodiment, but differs in the configuration that each of the first and second prism units 4, 4′ further includes a refractive index matching layer 48 disposed between a respective one of the prisms 43 and a respective one of the substrates 41, 41′. The refractive index matching layer 48 is made of refractive index matching oil which is selected from silicon-based oil and gel. A refractive index of the refractive index matching oil ranges from 1.38 to 1.62, and a viscosity coefficient thereof ranges from 5000 to 1100000 cps. Naturally, in practice, the refractive index matching oil may be made of other materials as long as the refractive index of the material is close to those of the prisms 43 and the substrates 41, 41′.

The method for manufacturing this embodiment is substantially the same as that for manufacturing the first preferred embodiment, and the differences between the two methods reside in that: for each of the first and second prism units 4, 4′, when disposing the prism 43 of this embodiment adjacent to the substrate 41 (41′), the prism 43 and the substrate 41 (41′) must be respectively fastened by jigs, the second surface 412 of the substrate 41 (41′) is applied with the refractive index matching oil, and the prism 43 is pressingly fixed onto the second surface 412 of the substrate 41 (41′). The refractive index matching oil may flow to fill clearances formed between the prism 43 and the substrate 41 (41′), such that the prism 43 is attached to the substrate 41 (41′) through viscosity and surface tension of the refractive index matching oil. Moreover, a rubber gasket (not shown) may be sleeved on the prism 43 and the substrate 41 (41′) so as to seal up the refractive index matching oil among the prism 43, the substrate 41 (41′), and the rubber gasket.

The refractive index matching oil is utilized during manufacture for expelling air between the prism 43 and the substrate 41 (41′), so as to reduce energy loss of light moving between different media as a result of air between the prism 43 and the substrate 41 (41′) (i.e., Fresnel loss).

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An optical device comprising a first prism unit, a second prism unit spaced apart from said first prism unit, and a spacer unit disposed between said first and second prism units;
wherein each of said first and second prism units includes:
a substrate having a first surface disposed to face the other one of said first and second prism units, and a second surface opposite to said first surface;
an anti-reflection coating disposed on said first surface of said substrate; and
a prism disposed adjacent to said second surface of said substrate; and
wherein said spacer unit is disposed between said anti-reflection coatings of said first and second prism units.

2. The optical device as claimed in claim 1, wherein said spacer unit includes a plurality of spacers that are spaced apart from each other and that are made of glass.

3. The optical device as claimed in claim 1, wherein said spacer unit is made of photoresist material.

4. The optical device as claimed in claim 1, wherein said spacer unit is made of optical fiber material.

5. The optical device as claimed in claim 1, wherein said anti-reflection coatings of said first and second prism units are spaced apart from each other by a distance ranging from 5 micrometers to 20 micrometers.

6. The optical device as claimed in claim 1, further comprising a field lens proximate to said first prism unit for converging light beams reflected by said first prism unit.

7. The optical device as claimed in claim 1, wherein, for each of said first and second prism units, said prism is disposed on said second surface of said substrate.

8. The optical device as claimed in claim 1, wherein each of said first and second prism units further includes a refractive index matching layer located between said substrate and said prism.

9. The optical device as claimed in claim 8, wherein said refractive index matching layer includes a refractive index matching material selected from silicon-based oil and gel.

10. A method for manufacturing an optical device, comprising the steps of:
(A) providing a first substrate unit and a second substrate unit, each having a substrate with opposite first and second surfaces, and an anti-reflection coating formed on the first surface of the substrate;
(B) disposing a spacer unit on at least one of the anti-reflection coatings of the first and second substrate units;
(C) stacking together the first and second substrate units with the spacer unit disposed between the anti-reflection coatings of the first and second substrate units;
(D) bonding the first and second substrate units and the spacer unit together; and
(E) for each of the first and second substrate units, disposing a prism adjacent to the second surface of the substrate.

11. The method as claimed in claim 10, wherein step (B) includes applying an adhesive to the anti-reflection coating, and disposing the spacer unit on the adhesive.

12. The method as claimed in claim 11, wherein the adhesive is an ultraviolet light curable adhesive, and step (D) includes curing the adhesive by irradiation with ultraviolet light.

13. The method as claimed in claim 10, wherein step (B) includes:
disposing a spacer layer made of photoresist material on the anti-reflection coating; and
removing parts of the spacer layer through photolithography etching techniques such that non-removed parts of the spacer layer form the spacer unit.

14. The method as claimed in claim 10, wherein, in step (E), the prism is cemented onto the second surface of the substrate.

15. The method as claimed in claim 10, wherein, in step (E), for each of the first and second substrate units, a refractive index matching material is applied to the second surface of the substrate before fixing the prism to the second surface of the substrate.

16. A projector apparatus comprising a light source, an optical device as claimed in claim 1, a digital micromirror device disposed at one side of said first prism unit of said optical device, and a projector lens;
wherein said first prism unit of said optical device is disposed to reflect light beams emitted from said light source toward said digital micromirror device, and said digital micromirror device is disposed to reflect the light beams received from said first prism unit such that the light beams reflected by said digital micromirror device pass through said first and second prism units and enter said projector lens.

17. The projector apparatus as claimed in claim 16, further comprising a reflecting unit disposed at one side of said optical device, the light beams emitted from said light source being directed toward said reflecting unit and being reflected by said reflecting unit to enter said first prism unit of said optical device.

18. A projector apparatus comprising a light source, an optical device as claimed in claim 1, a digital micromirror device disposed at one side of said first prism unit of said optical device, and a projector lens;
wherein light beams emitted from said light source pass through said first and second prism units toward said digital micromirror device, said digital micromirror device is disposed to reflect the light beams passing through said first and second prism units toward said first prism unit, and said first prism unit is disposed to reflect the light beams received from said digital micromirror device toward said projector lens.
